(19) United States
(12) Patent Application Publication
(10) Pub. No.: US 2017/0322421 A1
(43) Pub. Date: Nov. 9, 2017

(54) INTRINSICALLY SAFE SAFETY GOGGLES WITH DATA DISPLAY, USER INPUT AND DATA COMMUNICATION

(71) Applicants: M-I Drilling Fluids UK Limited, Westhill (GB); M-I L.L.C., Houston, TX (US)

(72) Inventors: Martin HUNTER, Aberdeen (GB); Richard A. FAGIN, Richmond, TX (US)

(21) Appl. No.: 15/319,476

(22) PCT Filed: Jun. 19, 2015
(86) PCT No.: PCT/US15/36592

§ 371 Date: Dec. 16, 2016

Related U.S. Application Data
(60) Provisional application No. 62/014,243, filed on Jun. 19, 2014.

(51) Int. Cl. G02B 27/01; G06F 3/01; G06F 3/02

(52) U.S. Cl. CPC G02B 27/0176; G06F 3/0202; G06F 3/01; G02B 2027/0178

(57) ABSTRACT

An apparatus includes a frame fittable to a human wearer's face. The frame has therein at least one lens in a field of view of the human wearer. The at least one lens includes a computer display functionally associated therewith. A computing system is embedded in a part of the frame. The computing system and the computer display are embedded so as to be hermetically sealed in the part of the frame and the at least one lens, respectively.

### RELATED APPLICATIONS

This application claims the benefit of U.S. Provisional Application having Ser. No.: 62/014243 filed Jun. 19, 2014, which is incorporated by reference in its entirety.

### Background

This disclosure is related to the field of user wearable data displays having user input and communication features. More specifically, the disclosure relates to such displays adapted for use in hazardous environments.

U.S. Pat. No. 8,203,502 issued to Chi et al. discloses a user-wearable “heads up” data display (i.e., wherein the data display is in the ordinary field of view of the wearer). The disclosed display may include various wearer input devices, such as a capacitive or resistive touch pad, and may a data communication subsystem (e.g., BLUETOOTH radio frequency data transceiver according to standard 802.15.1 promulgated by the Institute of Electrical and Electronics Engineers—“IEEE”) for communication of data between the data display and a wireless communications device such as an Internet enabled handset (cell phone) and/or “wi-fi” transceiver according to IEEE standard 802.11 (b), (g) and/or (n). A wi-fi transceiver may communicate with any similar wireless communication device such as a wireless router or wireless access point. The user-wearable data display may include a camera to generate an image of what is observed visually by the wearer and communicate such image when the wearer enters certain operating commands using the data display and user input device.

Certain environments, for example proximate a drilling unit drilling a wellbore though hydrocarbon bearing formations, may create specific hazards for personnel working in such areas. For example, head protection may be required to mitigate risk of injury from falling objects and eye protection may be required to mitigate risk from debris and splashes of hazardous liquids.

Further, such environments may be subject to safety requirements applicable to equipment in general and electrically operated equipment in particular. Such safety requirements may be imposed by agencies of government having jurisdiction over the type of and the place of operation. In the case of electrically operated equipment, hazardous environments may require the use of “intrinsically safe” and “explosion proof” equipment.

In normal use, electrical equipment can create internal tiny sparks in switches, motor brushes, connectors, and in other places. Electrical equipment generates heat as well, which under some circumstances can become an ignition source. Electric arcing is also a consideration.

There are multiple ways to make equipment explosion-proof, or safe for use in ex-hazardous areas. Intrinsic safety (IS) is one of a few methods available for ex-hazardous areas. Others include explosion proof enclosures, venting, oil immersion, powder and/or sand filling of circuit enclosures, and hermetic sealing. For hand-held electronic devices, IS may be a practical design method that allows a functional device to be used in certain hazardous environments. An IS device is designed to be incapable of producing heat or spark sufficient to ignite an explosive atmosphere.

There are several considerations in designing IS electronics devices: reducing or eliminating internal sparking, controlling component temperatures, and providing component spacing that would allow dust to short a circuit. Elimination of spark potential within components is accomplished by limiting the stored energy in any given circuit and the system as a whole. Temperature, under certain fault conditions such as an internal short circuit in a semiconductor device, may become hazardous of the temperature of a component can rise to a level that can ignite some explosive gasses, even in normal use. Current limiting by resistors and fuses may be used to ensure that in no circumstance can any component in an electronic device reach a temperature that could cause autoignition of a combustible atmosphere. In highly compact electronic devices using printed circuit boards (PCBs), the PCBs may have component spacing that create the possibility of an arc between components if dust or other particulate matter works into the circuitry, thus component spacing, siting and isolation such as by hermetic sealing or other sealed encapsulation become important to the design.

The primary concept in IS electronic device design is the restriction of available electrical and thermal energy within the device so that ignition of a hazardous atmosphere (explosive gas or dust) cannot occur. This may be obtained by ensuring that only low voltages and currents enter the hazardous area, and that no significant energy storage is possible.

One known method for IS circuit design is to limit electrical current by using multiple series resistors (assuming that resistors always fail “open”, i.e., as an open switch) in the circuit and to limit the voltage with multiple zener diodes connected to a “ground” potential bus or terminal (assuming zener diodes always fail “shorted”, i.e., as a closed switch). Sometimes a barrier known as a galvanic isolation barrier may be used. Certification standards for IS designs, which vary by device type, generally require that the galvanic isolation barrier not exceed approved levels of voltage and current with specified damage to limiting components.

IS equipment or instrumentation may be designed to operate with low voltage and current, and will be designed without any capacitors or inductors of sufficient size that could discharge so as to create a spark. The equipment or instrumentation used in the hazardous area may be connected, using approved wiring methods, or IS wireless communication devices back to a control panel or data processing and/or communication device disposed in a non-hazardous area that contains safety barriers to isolate such device from the hazardous area. The safety barriers ensure that, no matter what accidental contact occurs between the equipment or instrumentation circuit and any outside power sources, no more than the approved voltage or current enters the hazardous area.

### BRIEF DESCRIPTION OF THE DRAWINGS

FIG. 1 shows an example embodiment of intrinsically safe (IS) safety goggles according to the present disclosure.

FIG. 2 shows another example embodiment of IS safety goggles according to the present disclosure.

FIG. 3 shows an example embodiment of embedded electronic components of IS safety goggles

FIG. 4 shows an example of displays and controls associated with an intrinsically safe (IS) safety goggles according to the present disclosure.

FIG. 5 shows an example of electronic components that may be embedded in any portion of a goggles frame as in FIGS. 1-3.

### DETAILED DESCRIPTION

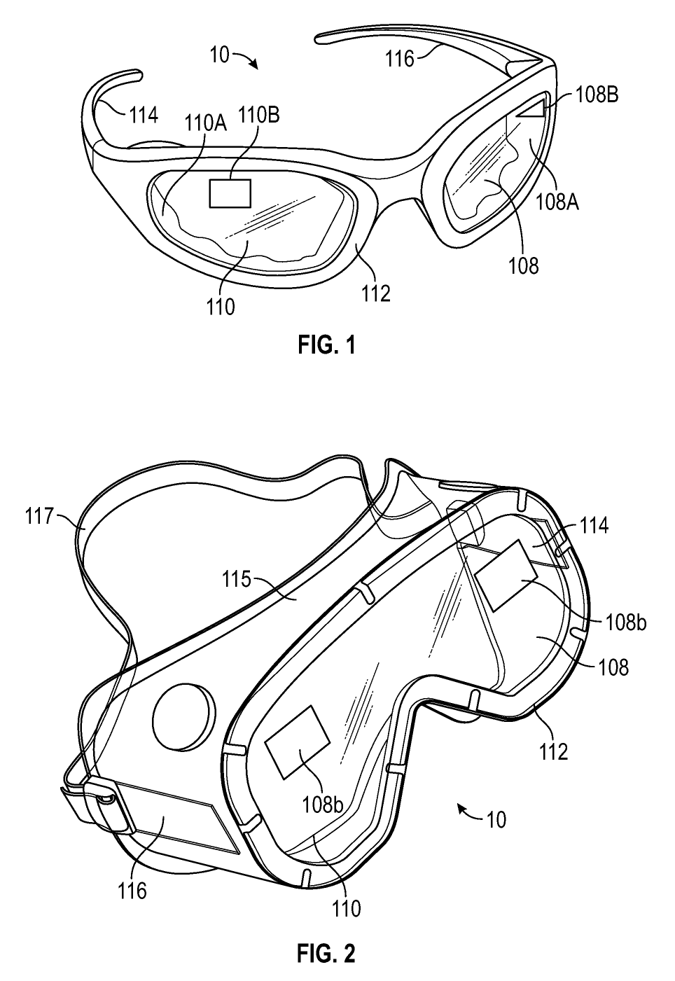

FIG. 1 shows an example embodiment of intrinsically safe (IS) safety goggles 10. The IS safety goggles 10 may include a frame 112 shaped in the form of ordinary eyeglasses or safety glasses surrounding a first lens 108 and a second lens 110. A first frame side 114 and a second frame side 116 may each be shaped to fit over the ears of a human wearer (hereinafter “wearer”). A portion of the frame 112 that surrounds each of the first lens 108 and the second 110 may include a corresponding first and second flexible seal, 108A, 110A, respectively on the side of the frame 112 that faces the wearer so that the wearer's eyes may be protected from splashes of harmful liquids and/or entry of debris into a space between the first and second lenses 108, 110 and the wearer. The flexible seal 108A, 110A may be made from flexible plastic, for example and without limitation flexible polyurethane. The frame 112 and the frame sides 114 may be made from impact resistant, chemical resistant plastic such as polycarbonate or acrylonitrile butadiene styrene (ABS). The first and second frame sides 114, 116 may be hingedly coupled to the frame 114 or may be formed integrally with the frame 112. If the frame sides 114, 116 are hingedly coupled, hinges (not shown) may be made entirely from plastic, e.g., ABS or polycarbonate to avoid having exposed material capable of generating a spark if the IS safety goggles 10 come into contact with a spark susceptible material (e.g., such as by dropping the IS safety goggles on a metallic surface).

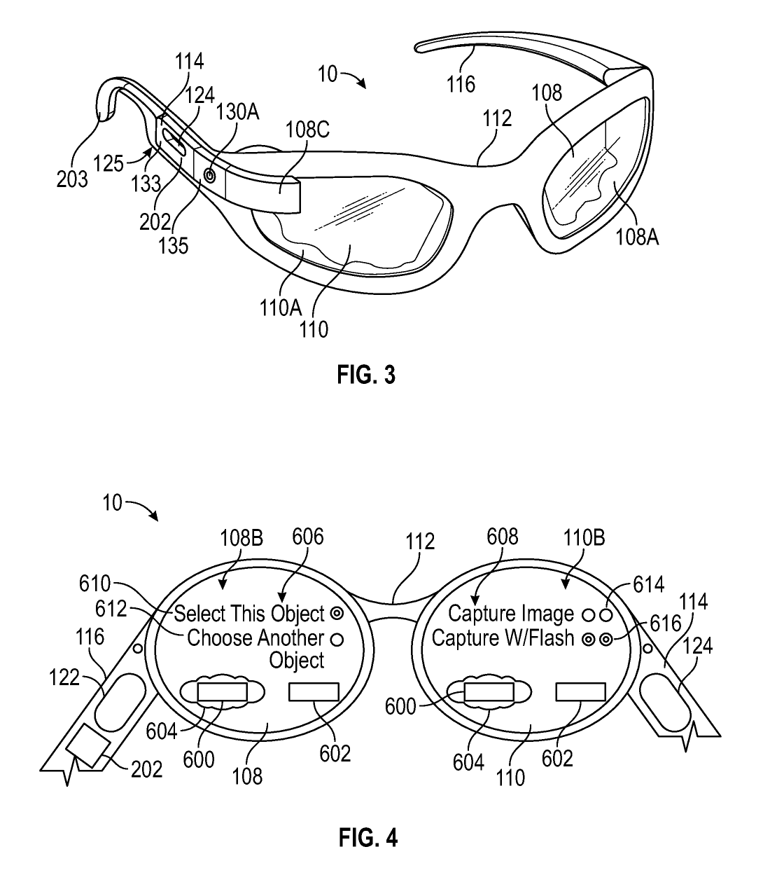

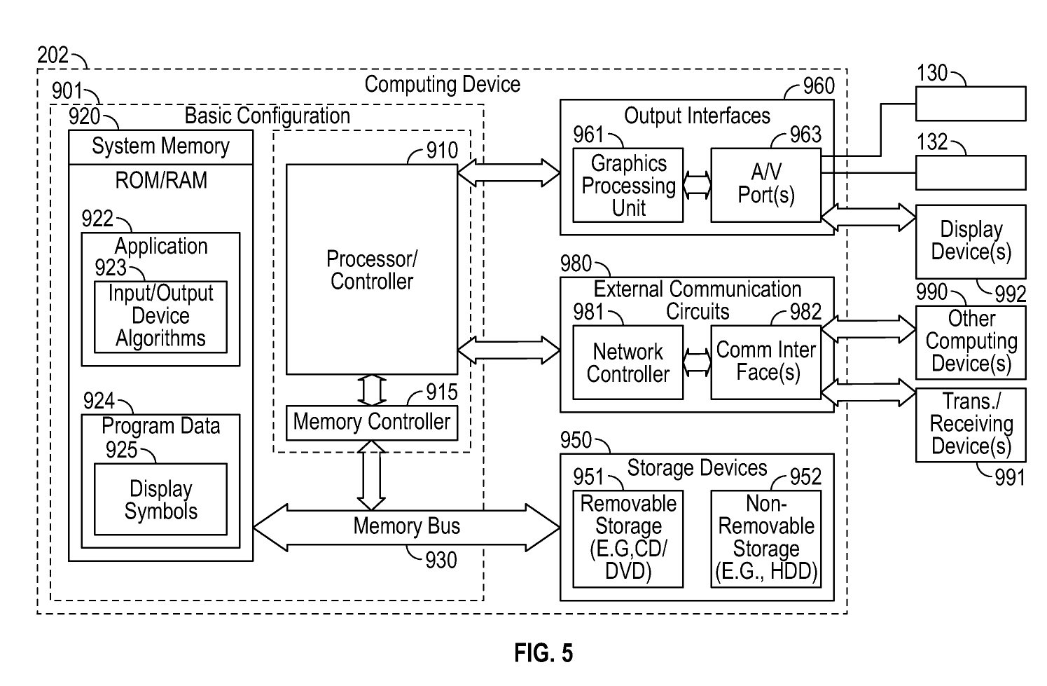

The first lens 108 and the second lens 110 may be made from transparent, shatter resistant plastic such as polycarbonate and may include embedded therein a respective electrically operated computer display 108B, 110B such as a liquid crystal display (LCD). In other embodiments, the frame 112 may include one or more laser diodes (not shown) embedded thereon and in signal communication with a computing system (202 in FIG. 5) to perform as the computer displays. In other embodiments as will be explained with reference to FIG. 3, a light emitting diode (LED) display may be associated with the computing system (202 in FIG. 5) and have optical elements to project an output of the LED display onto either or both of the first lens 108 and the second lend 110.

In one embodiment, the frame 112 and frame sides 114, 116 may be molded or otherwise formed integrally and include therein electronic components that will be further explained with reference to FIG. 5. In one example, such electronic components may be preassembled and disposed inside the material of the frame 112 and/or frame sides 114, 116 when the foregoing are made, e.g., by molding, so that the electronic components are effectively sealed from the environment outside the frame 112 and frame sides 114, 116. The displays 108B, 110B may be electrically connected certain of such electronic components at the interface between the frame 112 and either or each of the first lens 108 and the second lens 110, and such electrical connections may be sealed from the external environment using a sealing compound, e.g., room temperature vulcanizing (RTV) silicone or after-application curable polyurethane. Such curable polyurethane may include, without limitation compounds that require mixing of a curing activator, or polyurethane compounds that cure upon exposure to certain types of radiation. See, for example, U.S. Pat. No. 7,142,831 issued to Metzbower t al.

In another embodiment shown in FIG. 2, the frame 112, the frame sides 114, 116, the first and second lenses 108, 110 and a full surround wearer face seal 115 may be molded integrally as a single unit. Materials for the example embodiment shown in FIG. 2 may include polycarbonate so that the first and second lenses 108, 110 may be formed integrally with the frame 112 and frame sides 114, 116. The IS safety goggles 10 as shown in FIG. 2 may not include separate frame sides (114, 116 in FIG. 1) that fit over the wearer's ears, and so may be retained on the wearer's face by an elastic strap 117. One possible advantage of molding the above described components of the IS safety goggles 10 as an integral unit is that it then becomes possible to embed all the electrical circuitry (to be explained with reference to FIG. 5) within the material of the IS safety goggles 10 and thereby effectively hermetically seal the circuitry from the external environment. As set forth in the Background section herein, hermetic sealing is one possible aspect of making an electronic device intrinsically safe.

An IS camera (see, e.g., FIG. 3) may be affixed to the frame 112 during the forming of the frame 112. In some embodiments, the IS camera may be molded into a forward end of one of the frame sides (e.g., 114, 116 in FIG. 1 or on the wearer face seal 115 in FIG. 2) and optically aligned so that an image field of the IS camera corresponds to a field of view of a wearer of the IS safety goggles 10. All electrical connections between the IS camera and electronic components (FIG. 5) disposed within the material of the frame 112, frame sides (114, 116 in FIG. 1) and/or the wearer face seal 115 may also be molded within the material thereof so that no electrical connections between the IS camera (FIG. 3) and the electronic components (FIG. 5) are exposed to the external environment. One non-limiting example embodiment of an IS camera may be obtained from Pixavi, A. S., Domkirkeplassen 2, 4006 Stavanger Norway.

An example IS “headset” (ear worn speaker and microphone) may similarly be molded into the frame 112, either frame side (114, 116 in FIG. 1) or the wearer face seal 115 to enable audio communication using the IS safety goggles 10. In some embodiments, the electrical connections between the IS headset and the electronic components (FIG. 5) may be molded entirely within the frame 112. the frame sides (114, 116 in FIG. 1) or the wearer face seal 115 so that the electrical connections will be isolated from the external environment. One embodiment of an IS headset may also be obtained from Pixavi, A. S.

FIG. 3 shows another example embodiment of IS safety goggles 10A including a camera 130A, a microphone 135, a bone conduction speaker 133, a battery 203 and a computing system 202 affixed to a semi-rigid or rigid frame support 12A. The battery 203 may be disposed in a separate compartment at the end of the frame support 12A, or may be disposed in a component case 125 to be explained below. In some embodiments, the battery 203 may be rechargeable by an electromagnetically coupled charger (not shown) which enables the battery 203 to be recharged without having to remove it from the material of the frame 112 or frame side 114, 116, thus enabling the battery to be hermitically sealed to the same extent as all the other electronic components.

The bone conduction speaker 133 may be enclosed in a common electronic component case 125 as the camera 130A, the microphone 135 and the computing system 202. A prism 108C may project images from a computer display (not shown in FIG. 4A) such as an LED display, onto one of the lenses, shown at 110, or directly into the field of vision of the wearer. The computer display (not shown) may be in signal communication with and disposed in the case 125 proximate the computing system 202. The entire assembly of electronic components shown in FIG. 3 as described above may be embedded in the material of the frame 112 and/or one of the frame sides, e.g., 114. The embodiment shown in FIG. 3 may include at least one touch pad 124 as will be further explained with reference to FIGS. 4 and 5. By embedding the entire assembly of components shown in FIG. 3 in the material of the frame 112 and/or the frame sides 114, 116, the electronic components may be made intrinsically safe to the extent they are not already so by reason of unsealed electrical contacts. Making the foregoing components IS may result from hermetic sealing by reason of embedding the components in the material of the frame 112 and/or frame sides 114, 116. The embodiment shown in FIG. 3 may include all the components shown in FIG. 1, including the frame 112, the first and second frame sides 114, 116, the first and second lenses 108, 110 and corresponding seals 108A, 108B. In order to enable free passage of light into the camera 130A, the frame 112 and frame sides 114, 116 may be made from transparent plastic such as polycarbonate. As configured according to what is shown therein the embodiment of FIG. 3 may also protect the wearer's eyes from debris and hazardous liquids. It should be clearly understood that the electronic components shown in FIG. 3 may be embedded into a frame configured as shown in FIG. 2 with equal effect as to their operation and intrinsic safety.

FIG. 4 illustrates an example embodiment of functionality of electronic components of the IS safety goggles 10 wherein the electronic components may be embedded into the first and second frame sides (114, 116 in FIG. 1 or FIG. 3). The electronic components may include the previously mentioned computing device 202, to be explained in more detail with reference to FIG. 5, that may accept as input signals from the IS camera (130 in FIG. 3 or 130A in FIG. 4A), may operate audio communication through the IS headset (e.g., 133 and 135 in FIG. 3), may drive the displays, e.g., liquid crystal displays (LCDs) 108B, 110B embedded in the respective first and second lenses 108, 110 (or LED display and prism 108C in FIG. 3) and may accept user input from first and second capacitive touch pads 122, 124 each embedded in a respective one of the first and second frame sides 114, 116. Capacitive touch pads may be used as a wearer input device because the active components may be completely embedded in the material used to make the first and second frame sides 114, 116 and thus the capacitive touch pads 122, 124 may be isolated from the external environment. The computing device 202 may be electrically connected to batteries (FIG. 3) in a manner such as described in the Background section herein such that an amount of current available to the computing device 202, the IS camera (FIG. 3), the IS headset FIG. 3) and the displays 108B, 110B may be limited to avoid generating sufficient heat so as to exceed a glass transition temperature of the material used to make the frame 112 and the frame sides 114, 116.

FIG. 4 also shows example interactions with wearer observed objects that may be performed by the wearer using the one or more touch pads, e.g., as shown at 122, 124. In the present example embodiment, each touch pad 122, 124 may be a capacitive touch pad embedded in the material forming the respective frame side 114, 116 and operated independently, and may provide different corresponding functions. When operating independently, one of the touch pads 122, 124 may be associated with a wearer's dominant hand, and the other may be associated with a user's non-dominant hand. For example, assuming a right-handed user is wearing the IS safety goggles 10 of FIG. 4, the second touch pad 124 may be associated with the user's dominant hand, while the first touch pad 122 may be associated with the user's non-dominant hand. Different functions may be assigned to similar input operations executed at a respective touch pad 122, 124 based on such distinction. For an assumed left handed wearer, the functions of the first and second touch pads 122, 124 may be reversed from the example shown in FIG. 4.

As shown in FIG. 4, wearer-observed objects 600 and 602 are viewable through the first and second lenses 108, 110. For example, an observed object 600 is illustrated as a first object, while another observed object 602 is illustrated as a second observed object. While observed objects 600 and 602 are shown twice (in each of the lenses 108 and 110), it should be understood that there is really only one of each such object 600 and 602 within the wearer's field of view. The doubling of observed objects in FIG. 4 is shown to illustrate the binaural vision characteristics of the wearer (e.g., viewing the objects 600, 602 from two slightly different offset angles). A selection indicator 604 may be a superimposed selection indicator formed on respective lenses 108 and/or 110. The IS camera (130A in FIG. 3) may be configured to generate an image corresponding to the the wearer's field-of-view, and the computing system 202 may have programming therein to enable recognition of particular objects for selection, such as the first viewable image 600 and/or the second viewable image 602. Help displays 606 and/or 608 may be formed in either or both of the lenses 108, 110 (e.g., by the corresponding computer displays 108B, 110B in FIG. 1) to provide the wearer with options for interacting with the first and second observed objects 600, 602. For example, help displays 606 and 608 may be displayed simultaneously, may be displayed only one at a time, or may be displayed such that one of the help displays 606, 608 is augmented in corresponding overlapping areas of help displays 606 and 608.

Help display 606 may provide, for example, functions and associated commands for selecting an object recognized by computing system 202 (e.g., using the camera 130A in FIG. 3). For example, a selection indicator 604 may be displayed over a randomly selected object out of a plurality of objects recognized by the computing system 202 (or, for example, displayed over an object that the wearer is interested in). As shown in FIG. 4, the first observed object 600 may be initially selected. The selection indicator 604 may be displayed in lens 108 and/or lens 110. The Select This Object command 610 in the help display 606 may be executed, for example, by double-tapping the second touch pad 124 with a single finger. Selecting the currently-highlighted object in such a manner may allow for further functions to be executed with respect to the selected observed object. For example, once an object is selected, the selected object may be used as a focus-point for taking a picture via an imaging device (not shown) integrated with the IS safety goggles 10. Additionally or alternatively, an image or information search may be conducted using an image of the selected object. For example, an image of the first viewable object 600 may be used to locate other images corresponding thereto using search functions available from a selected computer system in signal communication with the computing system 202 in the IS safety goggles 10, to conduct a product search function to find information available concerning the first observable object 600, or to obtain information regarding devices associated with the first observable object

The Choose Another Object command 612 of help display 606 may be executed by a single-tap on the second touch pad 124 with a single finger. The Choose Another Object command 612 may cycle through each of the plurality of recognized objects within the current field of view. For example, single-tapping touch pad 124 may cause the selection indicator 604 to move from the first observed object 600 to the second observed object 602 (and may simultaneously cause the selection indicator 604 to change its shape to accommodate the size and/or geometries of the second observed object 602). Once the second observable object 602 is selected, the Select This Object command 610 may be executed via a double-tap using a single finger on the second touch pad 124 to find information and/or images with respect to the second observed object 602.

The help display 606 may be displayed in the first lens 108 and/or the second lens 110 when the object selection application is first started, so as to remind the wearer of the available input commands, executable via the first 122 or second 124 touch pads, to navigate the object selection application. After displaying the help display 606 for a predetermined period of time (e.g., 1-5 seconds), the help display 606 may be removed from the displayed image. Subsequently, the help display 606 may be displayed upon demand (e.g., via a particular motion across the first touch pad 122 or the second touch pad 124 associated with displaying help display 606, a particular area of the first touch pad 122 or the second touch pad 124 associated with displaying help display 606, or an algorithm executing in the computing system 202 that detects that the wearer is having difficulty navigating via the first touch pad 122 or the second touch pad 124.

Help display 608 may provide, for example, functions and associated commands for capturing an image of a scene as observed through the lenses 108, 110, and as imaged by the camera (130A in FIG. 3). For example, the selection indicator 604 may provide a focal point for an image capture process via commands 614 and 616. The Capture Image command 614 of help display 608, in one non-limiting example, may be executed by a two-finger single-tap on touch pad 124 (illustrated with a symbol comprising two adjacent empty circles), and may cause the camera to capture an image without a flash, using the currently-selected object 600 as the focal point. The Capture With Flash command 616 of help display 606, for example, may be executed by a two-finger double-tap on the second touch pad 124 (illustrated with a symbol comprising two adjacent dotes within respective outer circles), and may cause the camera (130A in FIG. 3) to capture an image with a flash, using the currently-selected object, e.g. the first observed object 600 as the focal point. The input commands associated with the functions 614 and 616 may be modified by a wearer or by pre-programming the computing system (see FIG. 5), and stored in the computing system 202. Additionally, and similar to the description above relative to help display 606, help display 608 may be displayed only as necessary or as initiated by wearer operation of one of the touch pads 122, 124, and otherwise, may be removed from anything displayed on the first lens 108 or the second lens 110.

As set forth earlier, the first touch pad 122 and the second touch pad 124 may be used to provide separate, independent wearer control input to the IS safety goggles 10. In the arrangement illustrated on lens 110 in FIG. 4, and once again assuming a right-handed user, the first touch pad 122 may provide gross motor movement of the selection indicator 604 for image capture focusing purposes, and the second touch pad 124 may provide fine motor movement of the selection indicator 604 (for the same or different purpose). For example, the first touch pad 122 may allow the wearer to move the selection indicator 604 quickly to the top of the user's field of view via a relatively short upwards-swipe across the first touch pad 122 (e.g., a full swipe across touch pad 122 in the vertical direction may cause a greater than 50% movement of the selection indicator 604 across a user's field of view). On the other hand, the second touch pad 124 may allow a wearer to move the selection indicator 604 in small increments to fine tune the focus selection (e.g., a full swipe across touch pad 124 in the vertical direction may cause a less than 10% movement of the selection indicator 604 across a user's field of view). Other applications of using gross and fine motor input between the first touch pad 122 and the second touch pad 124 may also be implemented. Further examples of functionality that may be provided in some embodiments are disclosed in U.S. Pat. No. 8,203,502 issued to Chi et al. The foregoing touch pad functionalities and help displays are only illustrative examples and are in no way intended to limit the scope of the present disclosure

FIG. 5 shows a functional block diagram of an example embodiment of the computing device 202 for supporting the displays and input controls set forth above with reference to FIG. 4. The computing device 202 in a basic configuration 901 may include one or more processors or controllers (processor) 910 and a system memory 920. A memory bus 930 may be used for communicating between the processor 910 and the system memory 920. Depending on the desired configuration, the processor 910 may be be of any type including, but not limited to, a microprocessor (μP), a microcontroller (μC), a digital signal processor (DSP), or any combination thereof. A memory controller 915 may also be used with the processor 910, or in some implementations, the memory controller 915 may be an internal part of the processor 910.

Depending on the desired configuration, the system memory 920 may be of any type suitable for inclusion in the component case (125 in FIG. 3) including but not limited to volatile memory (such as RAM), non-volatile memory (such as ROM, flash memory, etc.) or any combination thereof. The system memory 920 may include one or more applications 922 and program data 924. An application memory 922 may include algorithms such as input/output device interface algorithms 923 arranged to control and interface with input devices such as the first and second touch pads (122, 124 in FIG. 4), in accordance with the present disclosure. Other process descriptions or blocks in flow or message diagrams in the present disclosure should be understood as representing non-limiting example modules, segments, or portions of code which may include one or more executable instructions stored in the application memory 922 for implementing specific logical functions or actions in the process, and alternate implementations are included within the scope of embodiments of methods in which functions may be executed out of order from those shown or described herein, including substantially concurrently or in reverse order, depending on the functionality involved, as would be understood by those skilled in the art.

Program data 924 may include, among other things, display symbols 925 that correspond to commands that may be executed via corresponding touch pad (122, 124 in FIG. 4) operations (or other input interfaces), and that may be included in display data sent to one or more display devices 992. In some example embodiments, applications stored in application memory 922 can be arranged to operate with program data 924. The computing device 202 may have additional features or functionality, and additional interfaces to facilitate communications between a basic configuration 901 and any devices and interfaces. For example, the data storage devices 950 may be removable storage devices 951, non-removable storage devices 952, or a combination thereof.

Data storage devices 951 and 952 may include volatile and nonvolatile, removable and non-removable media implemented in any method or technology for storage of information, such as computer readable instructions, data structures, program modules, or other data. It will be appreciated by those skilled in the art that the data storage devices 951, 952 if fully embedded in any part of the frame (e.g., 112 in FIG. 3) such storage devices will both be non-removable.

System memory 920, storage media for use with storage devices 951, and 952 are all examples of computer storage media. The term “computer storage media” includes, but is not limited to any medium which can be used to store the desired information and which can be accessed by the computing system 202.

The computing system 202 may also include output interfaces 960 that may include a graphics processing unit 961, which can be configured to communicate to various external devices such as display devices 992 (which may include, for example, the LCD displays 108B, 110B embedded in the lenses 108, 110 in FIG. 2) or audio transducer. e.g., in the IS microphone and speaker (FIG. 3) via one or more A/V ports 963. The one or more A/V ports963 may also be in signal communication with the IS camera (130A in FIG. 3). External communication circuits 980 may further include a network controller 981, which may be arranged to facilitate communications with one or more other computing devices 990 and/or one or more transmitting and/or receiving devices 991. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. The encoded signal may be communicated through the communications interface 982 to a wireless transceiver (shown at 991). By way of example, and not limitation, the wireless transceiver 981 may include an IEEE 802.11 (b), (g) or (n) standard “wi-fi” communications transceiver. Because all the foregoing components of the computing system 202 may be embedded in the material forming the frame (112 in FIG. 3) or frame sides (e.g., 114, 116 in FIG. 3), none of the computing system components is exposed to the external environment.

The computing system 202 may be implemented as a portion of a small-form factor portable (or mobile) electronic device such as a multi-chip module (MCM), an application-specific integrated circuit (ASIC), a field-programmable gate array (FPGA). Other examples of computing system and/or system functionality are disclosed in U.S. Pat. No. 8,203,502 issued to Chi et al.

As explained above, the computing system and associated components may be supplied with electrical power by one or more batteries (FIG. 3). To avoid having exposed electrical connections, in the present example embodiment, the one or more batteries (FIG. 3) may also be fully embedded in the frame or frame side material and may include an electromagnetic charger receiver (not shown) so that the one or more batteries (FIG. 3) may be recharged as needed without the requirement to remove them from the IS safety goggles (10 in FIG. 3)

Thus, all of the electrical components of IS safety goggles made according to the present disclosure may be completely isolated from the external environment. An amount of electric current used to operate the various electronic components may be limited to prevent buildup of excessive heat. The materials from which the frame, frame sides and lenses are made may be shatter resistant, have thermal stability well within any expected temperatures to be generated by the embedded electronic components and may avoid generation of any sparks when the IS safety goggles contact any object within a hazardous area.

It should be further understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

An explosion proof communication transceiver, for example, a wi-fi (IEEE standard 802.11 (b), (g) or (n)) transceiver may be used in some embodiments to enable data communication between the IS safety goggles (10 in FIG. 1, FIG. 2 and FIG. 3) and any Internet connected device or other device on a local area network (LAN) such as a personal computer or a computer system (not shown). Such data communication may enable the wearer to access data related to observed objects (e.g., using the image generated by the camera 130A in FIG. 3), and may enable the wearer to execute control commands over certain observed objects that are recognized by the Internet connected device or LAN connected computer. When the observed object is recognized, a set of possible control commands may be transmitted to the IS safety goggles (10 in FIG. 1, FIG. 2 and FIG. 3) for display, e.g., in either or both of the lenses (as shown at 108 or 110 in FIG. 4) wherein the wearer may use either of the touch pads (122, 124 in FIG. 4) to select the desired displayed command. By having one or more explosion proof wi-fi (or other type) of explosion proof communications transceivers disposed at selected locations within the hazardous area, the computing system in the safety goggles may be maintained in signal communication with any other computing system, network or database while maintaining intrinsic safety. One embodiment of an explosion proof wi-fi transceiver may be obtained from Pixavi, A. S.

An apparatus according to the present disclosure includes a frame fittable to a human wearer's face. The frame has therein at least one lens in a field of view of the human wearer. The at least one lens includes a computer display functionally associated therewith. A computing system is embedded in a part of the frame. The computing system and the computer display are embedded so as to be hermetically sealed in the part of the frame and the at least one lens, respectively.

Although the preceding description has been made herein with reference to particular means, materials and embodiments, it is not intended to be limited to the particulars disclosed herein. Rather, it extends to all functionally equivalent structures, methods and uses, such as are within the scope of the appended claims.

What is claimed is:

1. An apparatus, comprising:
a frame fittable to a human wearer's face, the frame having therein at least one lens in a field of view of the human wearer, the at least one lens comprising a computer display functionally associated therewith; and
a computing system embedded in a part of the frame, the computing system and the computer display embedded so as to be hermetically sealed in the part of the frame and the at least one lens, respectively.

2. The apparatus of claim 1 further comprising a user input device embedded in a part of the frame.

3. The apparatus of claim 2 wherein the user input device comprises a capacitive touch pad.

4. The apparatus of claim 1 further comprising a camera embedded in a part of the frame and in signal communication with the computing system.

5. The apparatus of claim 1 further comprising a wireless data communication transceiver embedded in a part of the frame.

6. The apparatus of claim 1 further comprising a speaker and a microphone in signal communication with the computing system, wherein electrical connections between the ear wearable speaker and the microphone are embedded in a part of the frame.

7. The apparatus of claim 1 wherein the computer display comprises a liquid crystal display.

8. The apparatus of claim 1 wherein the computer display comprises a light emitting diode display.

9. The apparatus of claim 8 wherein the light emitting diode display has a prism coupled to an optical output of the light emitting diode display.

10. The apparatus of claim 1 wherein the at least one lens comprises polycarbonate.

11. The apparatus of claim 1 wherein at least one of the frame and the at least one lens comprise material unsusceptible to generation of sparks when contacting another material.

12. The apparatus of claim 11 wherein the material comprises polycarbonate.

13. The apparatus of claim 1 further comprising a wireless data communication transceiver embedded in a part of the frame.

14. The apparatus of claim 13 wherein the wireless data communication transceiver comprises an Institute of Electrical and Electronics Engineers standard 802.11 (b), (g) or (n) transceiver.

15. The apparatus of claim 1 further comprising a seal to sealingly enclose a space between the frame and the human wearer's eyes.
